(19) United States
(12) Patent Application Publication
(10) Pub. No.: US 2017/0233229 A1
(43) Pub. Date: Aug. 17, 2017

(54) Crane Load Location Warning System

(71) Applicant: Robert Burke, Paeonian Springs, VA (US)

(72) Inventor: Robert Burke, Paeonian Springs, VA (US)

(21) Appl. No.: 15/436,046

(22) Filed: Feb. 17, 2017

Related U.S. Application Data
(60) Provisional application No. 62/296,215, filed on Feb. 17, 2016.

(51) Int. Cl. B66C 15/06

(52) U.S. Cl. CPC B66C 15/06

(57) ABSTRACT

A method of alerting a person to the proximity of a load being carried by a crane includes generating a trigger signal from a crane operator station when a load being carried by a crane is in proximity to a person. A wireless alarm signal is transmitted from a transmitter in response to the trigger signal. The wireless alarm signal is received by a receiver in wireless communication with the transmitter. An alarm from an alarm device is created in response to receiving the wireless alarm signal by the receiver. The alarm device is suspended from a load line that carries the load to be in proximity with the load.

### CROSS-REFERENCE TO RELATED APPLICATIONS

This claims priority from U.S. provisional Application No. 62/296,215, filed Feb. 17, 2016, which is incorporated by reference in its entirety.

### FIELD

This relates to the field of worker safety devices and, more particularly, to safety devices for cranes.

### BACKGROUND

Safety is a major concern for people who work around heavy equipment such as a crane because the crane's load will often travel overhead and in close proximity to people. As a safety measure, cranes are often equipped with a horn to alert people that the crane is in operation, but these horns are not very effective because the crane horn usually positioned at the operator station, which is often far from the load the crane is carrying. Sounding the horn from the operator station does not help a worker determine where the load is located. People who work around cranes often ignore crane horns for this reason.

### SUMMARY

In view of the foregoing, it would be advantageous to have a crane load location warning system that allows people in proximity to the crane's load to easily determine the load's position.

An example of a method of alerting a person to the proximity of a load being carried by a crane that embodies this principle includes generating a trigger signal from a crane operator station when a load being carried by a crane is in proximity to a person. A transmitter then transmits a wireless alarm signal in response to the trigger signal. The wireless alarm signal is received by a receiver in wireless communication with the transmitter. An alarm device creates an alarm in response to receiving the wireless alarm signal by the receiver. The alarm device is suspended from a load line that carries the load. The alarm is detectable by the person.

A first example of the crane load location warning system includes a trigger that generates a trigger signal when the trigger is activated, the trigger being positioned at a crane operator station. A transmitter is in communication with the trigger and receives the trigger signal and transmits a wireless alarm signal in response to receiving the trigger signal. A receiver is in wireless communication with the transmitter and receives the wireless alarm signal. An alarm device is in communication with the receiver and generates an alarm detectable by humans in response to the receiver receiving the wireless alarm signal. The alarm device is suspended from a load line that carries a load movable by the crane.

A second example of the crane load location warning system includes a foot pedal at a crane operator station that generates a trigger signal when the foot pedal is activated. A transmitter is in communication with the foot pedal and receives the trigger signal and transmits a wireless alarm signal in response to receiving the trigger signal. A receiver is in wireless communication with the transmitter and receives the wireless alarm signal. An audio speaker is in communication with the receiver and generates a sound detectable by humans in response to the receiver receiving the wireless alarm signal. A battery powers the receiver and audio speaker. A container is suspended from a load line that carries a load movable by a crane. The container houses the receiver, speaker, and battery.

### BRIEF DESCRIPTION OF THE DRAWINGS

FIG. 1 is a side elevation view of a first example of a crane equipped with a crane load location warning system.

FIG. 2 is a side elevation view of a second example of a crane equipped with a crane load location warning system.

FIG. 3 is a top view of a wireless receiver component of first example of the warning system, showing the container open.

FIG. 4 is a bottom view of the wireless receiver component of FIG. 3, showing the container closed.

FIG. 5 is a top front perspective view of a second example of the wireless receiver component with the container closed.

FIG. 6 is a bottom front perspective view of the wireless receiver component of FIG. 5 with the container open.

FIG. 7 is a top back perspective view of the wireless receiver component of FIG. 5 with the container closed.

FIG. 8 is a right side perspective view of the wireless receiver component of FIG. 5 with the container closed.

FIG. 9 is a left side perspective view of the wireless receiver component of FIG. 5 with the container closed.

FIG. 10 is a top view of the wireless receiver component of FIG. 5 with the container open and the power supply installed.

FIG. 11 is a top perspective of the wireless receiver component of FIG. 5 with the container open and the power supply being removed.

FIG. 12 is a top view of the wireless receiver component of FIG. 5 with the container open and the power supply completely removed.

FIG. 13 is a bottom perspective view of the wireless receiver component of FIG. 5 attached to a crane hoist.

FIG. 14 is a top view of the trigger device and transmitter components of an example of warning system.

FIG. 15 is a flow diagram illustrating a method of alerting a person to the proximity of a traveling load.

### DETAILED DESCRIPTION OF EXAMPLE EMBODIMENTS

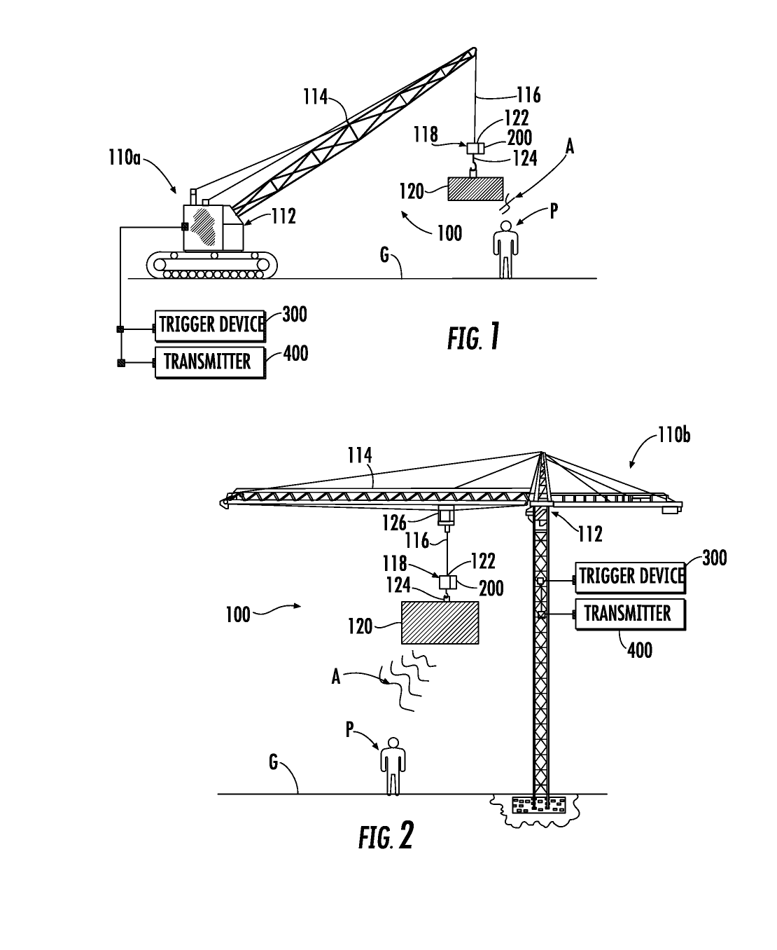

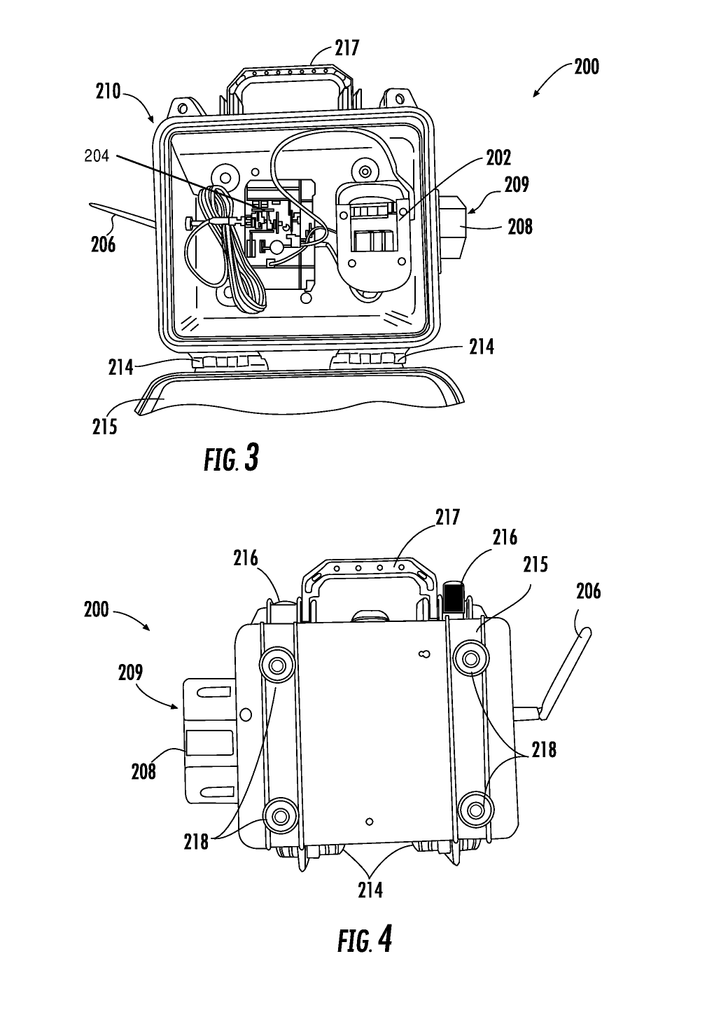

An example of the crane load location warning system 100 is shown in operation on two different types of cranes 110a, 110b in FIGS. 1 and 2. The crane 110a in FIG. 1 is a mobile crane whereas the crane 110b in FIG. 2 is a tower crane. The warning system 100 may be used with any type of crane, so it should be understood that these two crane types are simply used as examples to illustrate how the warning system 100 may be used.

Both of the cranes 110a,110b include an operator station 112 where a crane operator controls the crane by manipulating various crane controls. A boom 114 extends over the ground G and supports a load line 116 from which a hoist 118 is suspended. The hoist 118 is adapted to attach to the load 120 that the crane operator intends to move using the crane. In the examples shown, the hoist 118 includes a hoist block 122 and a hook 124, but there are many hoist configurations possible. The only requirement for the hoist 118 is that it be capable of attaching the load 120 to the crane 110a,110b so that the crane 110a,110b can lift the load 120.

The load 120 can travel in different directions. For example, the load 120 carried by a crane 110a,110b can travel up and down by extending or retracting the load line 116. It can also travel along a circular path by rotating the boom 114. The load 120 on the mobile crane 110a can travel laterally relative to the ground G by moving the crane 110a. The load 120 on the tower crane 110b can travel laterally relative to the ground G by moving a trolley 126 along the boom 114.

When the load 120 travels to a position where it is in proximity to a person P, the person may be in danger especially when the load 120 is overhead. The warning system 100 may be used to alert the person P to the proximity of the traveling load 120.

The warning system 100 includes a wireless receiver 200 that is attached to the crane 110a,110b in such a way that the wireless receiver 200 travels with the load 120. In the examples shown in FIGS. 1 and 2, the wireless receiver 200 is attached to the hoist 118 so that it remains in substantially the same position relative to the ground G as the load 120. The wireless receiver 200 can generate an alarm A that the person P can detect. Suitable types of alarms include audible and/or visible alarms. Because the wireless receiver 200 travels with the load 120 the alarm A will appear to the person P as if it comes from the load 120, thereby indicating to the person P the precise location of the load 120.

A trigger device 300 may be used to tell the receiver 200 to generate the alarm A. The trigger device 300 may be positioned at the operator's station 112 so that the operator can activate the trigger device 300 when the load 120 is in proximity to the person P.

When the trigger device 300 is activated, it generates an electronic trigger signal that is detected by a transmitter 400. When the transmitter 400 detects the trigger signal, the transmitter 400 transmits a wireless alarm signal to the receiver 200. And when the receiver 200 receives the alarm signal, the receiver 200 generates the alarm A in response.

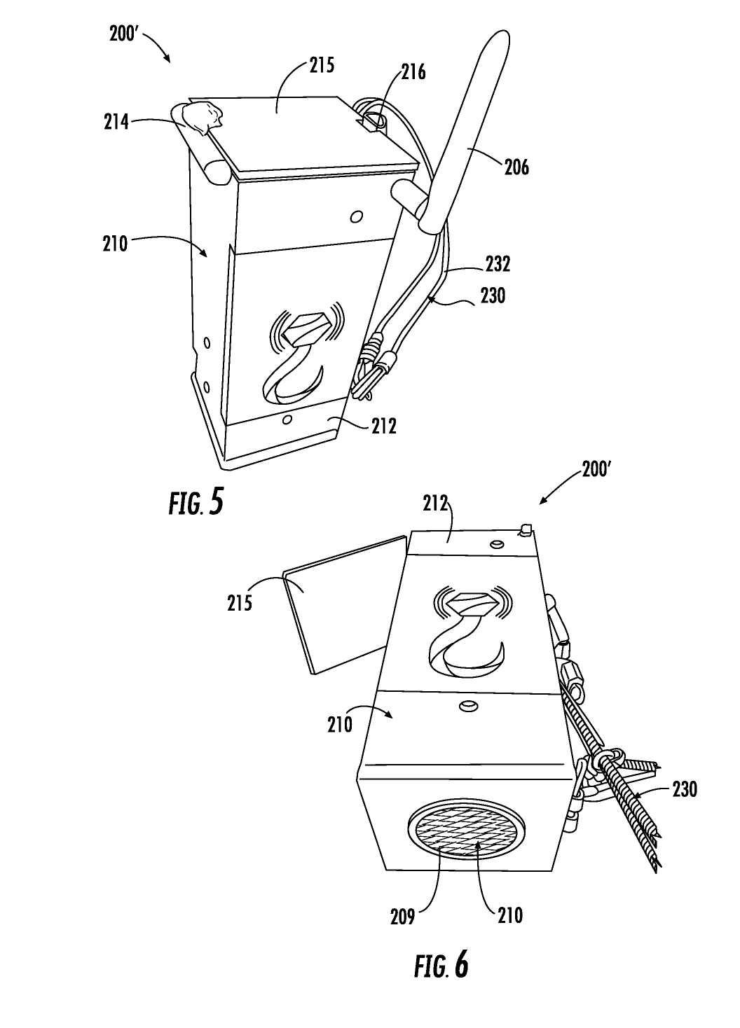

An example of a first configuration for the wireless receiver 200 is shown in FIGS. 3 and 4. The wireless receiver 200 includes a power supply 202, such as a battery or the like, electronic circuitry 204, an antenna 206, and an alarm device 208.

The power supply 202 provides power to the electronic circuitry 204, antenna 206, and alarm device 208. It may include a battery such as a rechargeable battery. Lithium ion or other types of rechargeable batteries are suitable examples.

In use, the antenna 206 receives the alarm signal from the transmitter 400. The electronic circuitry 204 registers receiving the alarm signal and switches on the alarm device 208. The electronic circuitry 204 includes a contact closure relay that closes when it registers receiving the alarm signal. When it closes, power from the power supply 202 flows to the alarm device 208, activating the alarm.

The alarm device 208 generates an alarm that is detectable by a person. The alarm may be in the form of an audible noise and/or an optical effect, for example. In the example shown in FIG. 5, the alarm device 208 is a speaker 209 that makes an audible noise.

The wireless receiver 200 may be adapted for portability. This is advantageous because it allows users to remove the wireless receiver 200 from the crane when not in use. Because many of the companies that use cranes rent them, it may be desirable to be able to remove the entire warning system 100 from the crane. Consequently, the trigger device 300 and transmitter 400 may be portable as well.

The help with portability and durability, the electronic circuitry 204 of the wireless receiver 200 is housed within a container 210. In the example shown in FIGS. 3 and 4, the container 210 is a suitcase-type container having a body 212, hinges 214 for opening and closing the container lid 215, fasteners 216 for holding the container 210 closed, and a handle 217 for carrying the container 210. The container 210 may be substantially waterproof to prevent the electronic circuitry 204 from being damaged by rain or weather.

The container 210 may also include one or more crane attachment members 218 that are capable of attaching the wireless receiver 200 to the crane. An attachment member 218 may take the form of one or more straps, fasteners, clips, magnets, or any other type of mechanism that can be used to attach the wireless receiver 200 to the crane. In the example shown, there are four attachment members 218 in the form of magnets attached to one side of the container 210. This configuration may be useful when the attachment point to the crane is made of a magnetic metal, which is often the case for many crane hoists 118. In the example of FIGS. 1 and 2, the wireless receiver 200 may be attached to a metal hoist 118 by the magnets.

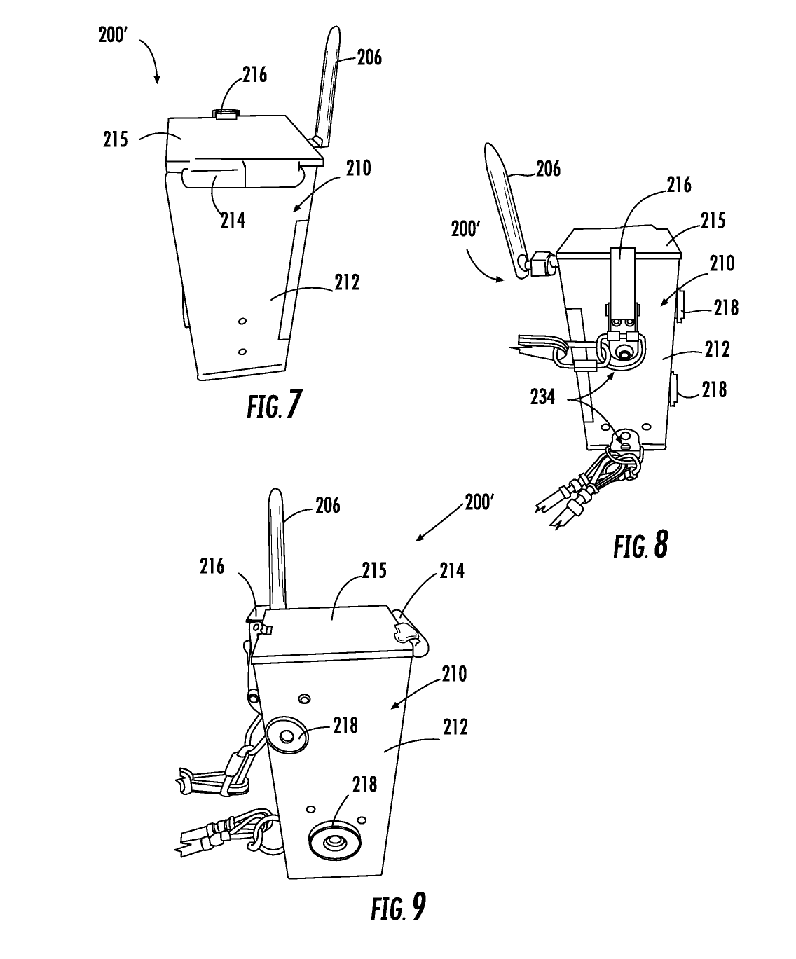

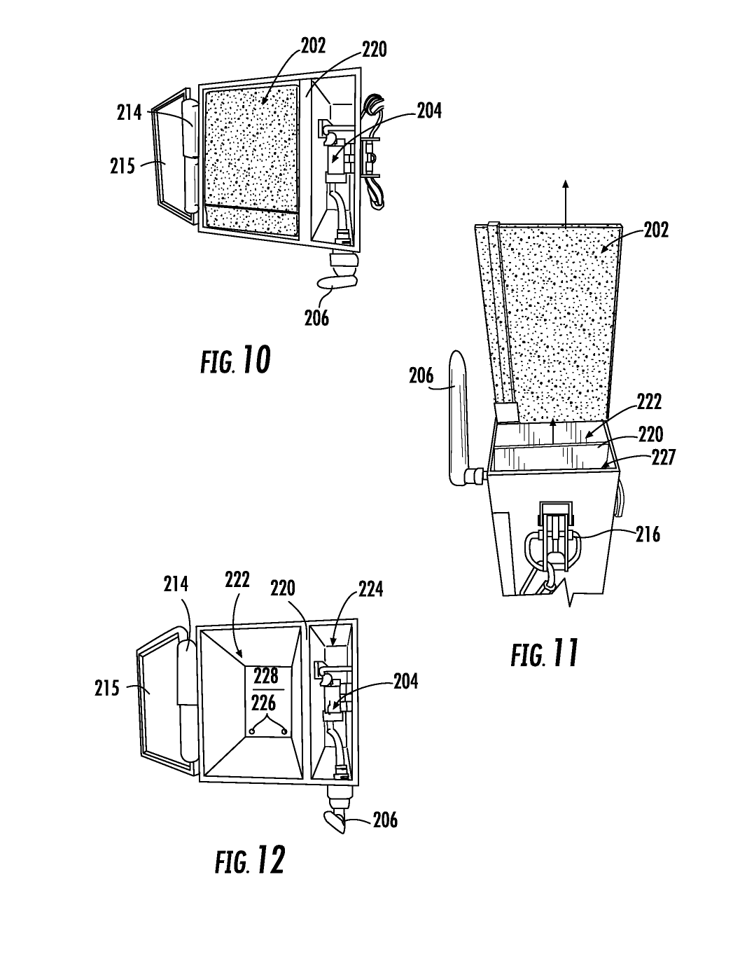

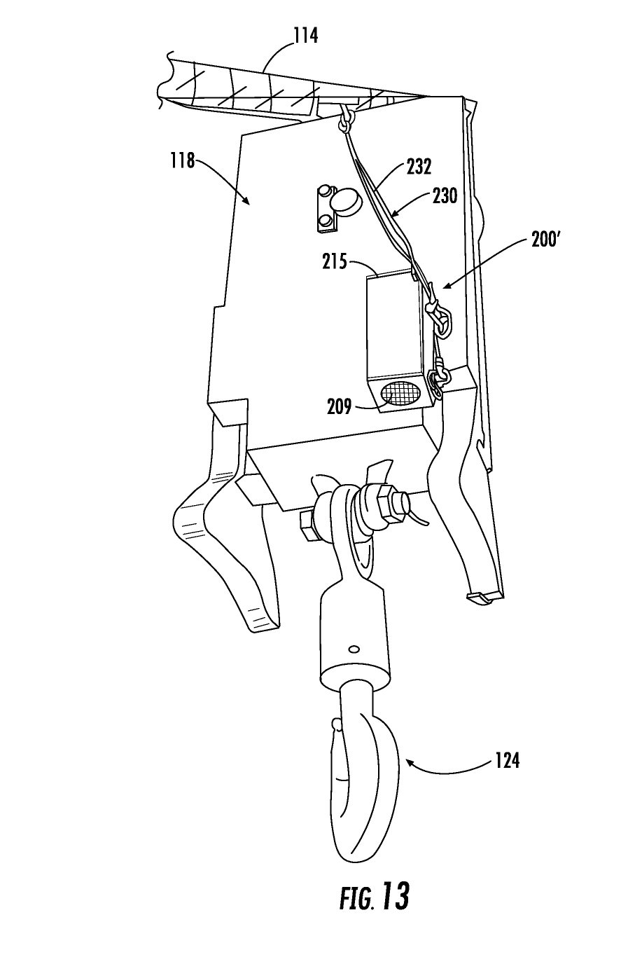

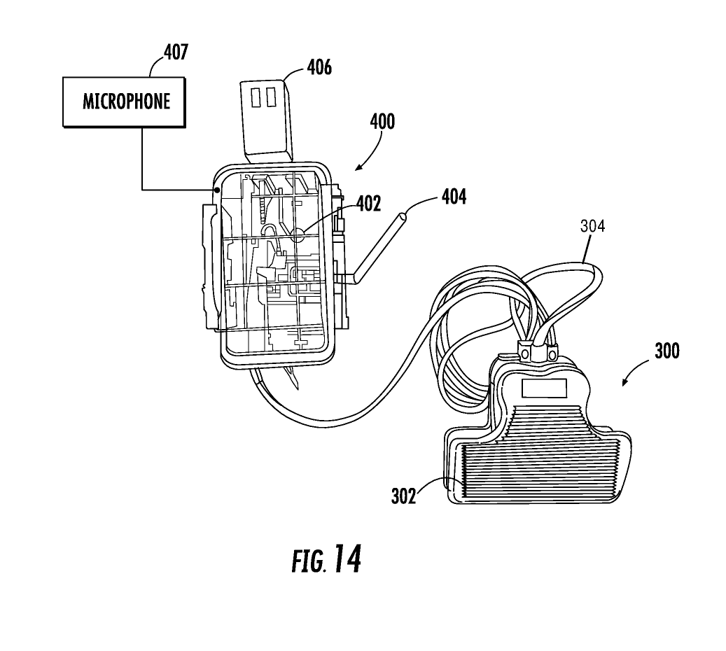

An example of a second configuration for the wireless receiver 200′ is now described with reference to FIGS. 5-12 with like numbers corresponding to like elements from the first example in FIGS. 3 and 4.

In the second example of the wireless receiver 200′, the inside of the container 210 includes a panel 220 that divides the inside into a battery compartment 222 and a circuitry compartment 224. As shown in FIG. 11, the battery power supply 202 is removable from the battery compartment 222 for charging or replacement. Metallic contact pins 226 at the base 228 of the battery compartment 222 provide the electrical connection between the battery power supply 202 and the electronic components such as the circuitry 204 and alarm device 208.

To prevent the wireless receiver 200′ from falling off the crane a tether 230 may be attached to the body 212. The tether 230 includes a cable 232 connected to the body 212 at a pair of attachment points 234. As shown in FIG. 13, the tether 230 may be secured to the hoist 118 by securing the cable 232 to a portion of the hoist 118.

The container 210 may be made of plastic, metal, or the like. The material selected is preferably rigid and strong enough to be used at a construction site where it may be bumped, dropped, and transported without damaging the components within the container.

An example of a possible configuration for the trigger device 300 and transmitter 400 is in FIG. 14. The trigger device 300 includes an electronic switch 302 that the operator can control. In this example, the switch 302 takes the form of a foot pedal that the operator can manipulate with his or her foot. Activating the switch 302, generates the electronic trigger signal, which is communicated via wiring 304 to the transmitter 400.

The transmitter 400 includes electronic circuitry 402 that detects the electronic trigger signal and, in response, generates an alarm signal that is transmitted from an antenna 404 to the wireless receiver 200. The electronic circuitry 402 includes a contact closure relay that closes when the trigger signal is detected, allowing power to flow to the antenna 404, activating transmission of the alarm signal to the wireless receiver 200.

The trigger device 300 and transmitter 400 are powered by an electricity source 406. In the example shown, the electricity source is a plug designed to plug into an outlet located within the operator's station 112. In other examples, however, the electricity source 406 may include a battery, solar panel, or another type of electricity source.

Wireless communication between the transmitter 400 and receiver 200, 200′ may be accomplished by conventional radio frequency wireless communications.

The warning system 100 may be equipped with a voice communication mechanism so that the crane operator may send voice commands via the speaker 209. In such an example, a microphone 407 in communication with the transmitter 400 may be positioned at the operator station 112.

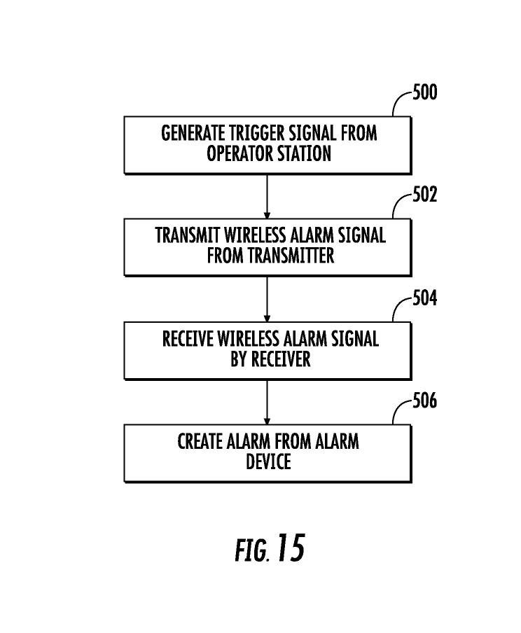

As discussed, the warning system may be used to alert a person to the proximity of a traveling load. A method of alerting a person to the proximity of a traveling load carried by a crane is now discussed with reference to FIG. 15.

At block 500, a trigger signal is generated from a crane operator station when a load carried by the crane is in proximity to a person. The trigger signal may be generated from the trigger device 300. For example, if the crane load is in the vicinity of people, the crane operator may activate the trigger device 300 from the operator's station.

At block 502, a wireless alarm signal is transmitted from the transmitter in response to the trigger signal. The wireless alarm signal may be a radio frequency signal that travels wirelessly to the receiver. At block 504, the receiver receives the alarm signal.

At block 506 an alarm is created from from an alarm device in response to receiving the wireless alarm signal by the receiver. The alarm device is suspended from a load line that carries the load. The alarm is detectable by the person, such as by noise and/or light.

This disclosure describes example aspects and embodiments, but not all possible aspects embodiments of the crane load location warning systems and methods. Where a particular feature is disclosed in the context of a particular aspect or embodiment, that feature can also be used, to the extent possible, in combination with and/or in the context of other aspects and embodiments. The systems and methods may be embodied in many different forms and should not be construed as limited to only the examples or embodiments described here.

That which is claimed is:

1. A method of alerting a person to the proximity of a load being carried by a crane, the method comprising:
generating a trigger signal from a crane operator station when a load being carried by a crane is in proximity to a person;
transmitting a wireless alarm signal in response to the trigger signal from a transmitter;
receiving the wireless alarm signal by a receiver in wireless communication with the transmitter; and
creating an alarm from an alarm device in response to receiving the wireless alarm signal by the receiver, the alarm device being suspended from a load line that carries the load, the alarm being detectable by the person.

2. The method of claim 1, wherein the trigger signal is generated by a foot pedal at the crane operator station.

3. The method of claim 1, wherein the trigger signal is generated by a trigger and the trigger and transmitter are both positioned at the crane operator station.

4. The method of claim 1, wherein the receiver and alarm device are housed by a container including a power supply that powers the receiver and alarm device.

5. The method of claim 1, wherein the receiver and alarm device are housed by a container including a power supply that powers the receiver and alarm device and the alarm device is an audio speaker pointing downwardly towards the ground.

6. The method of claim 1, wherein the trigger signal is generated when a contact closure relay closes and allows power to flow to the transmitter.

7. The method of claim 1, the alarm device includes a contact closure relay that closes after the receiver receives the wireless alarm signal, which allows power to flow to the alarm device thereby creating the alarm.

8. A crane load location warning system comprising:
a foot pedal at a crane operator station that generates a trigger signal when the foot pedal is activated;
a transmitter in communication with the foot pedal and that receives the trigger signal and transmits a wireless alarm signal in response to receiving the trigger signal;
a receiver in wireless communication with the transmitter and that receives the wireless alarm signal; and
an audio speaker in communication with the receiver and that generates a sound detectable by humans in response to the receiver receiving the wireless alarm signal;
a battery that powers the receiver and audio speaker; and
a container suspended from a load line that carries a load movable by a crane, the container housing the receiver, speaker, and battery.

9. The crane load location warning system of claim 8, wherein the foot pedal and transmitter are located at an operator station of the crane.

10. The crane load location warning system of claim 8, wherein the foot pedal and transmitter are located within an operator cabin of the crane.

11. The crane load location warning system of claim 8, wherein the container is suspended from the load line by being attached to a hoist of the crane.

12. The crane load location warning system of claim 8, wherein the container includes a tether having a cable attached to a hoist of the crane.

13. The crane load location warning system of claim 8, wherein the trigger signal is generated when a contact closure relay closes and allows power to flow to the transmitter.

14. The crane load location warning system of claim 8, wherein the container includes a contact closure relay that closes and allows power to flow from the battery to the audio speaker for emitting sound from the audio speaker.

15. A crane load location warning system comprising:
a trigger that generates a trigger signal when the trigger is activated, the trigger being positioned at a crane operator station;
a transmitter in communication with the trigger and that receives the trigger signal and transmits a wireless alarm signal in response to receiving the trigger signal;
a receiver in wireless communication with the transmitter and that receives the wireless alarm signal; and
an alarm device in communication with the receiver and that generates an alarm detectable by humans in response to the receiver receiving the wireless alarm signal, the alarm device being suspended from a load line that carries a load movable by the crane.

16. The crane load location warning system of claim 15, wherein the trigger includes a foot pedal.

17. The crane load location warning system of claim 15, wherein the trigger is wired to the transmitter and both the trigger and transmitter are positioned at the crane operator station.

18. The crane load location warning system of claim 15, wherein the receiver and alarm device are housed by a container including a power supply that powers the receiver and alarm device.

19. The crane load location warning system of claim 15, wherein the receiver and alarm device are housed by a container including a power supply that powers the receiver and alarm device and the alarm device is an audio speaker pointing downwardly towards the ground.

20. The crane load location warning system of claim 15, wherein the trigger signal is generated when a contact closure relay closes and allows power to flow to the transmitter.

21. The crane load location warning system of claim 15, wherein the alarm device includes a contact closure relay that closes and allows power to flow from a battery to the alarm device for emitting the alarm from the alarm device.
